(19) United States
(12) Patent Application Publication
(10) Pub. No.: US 2026/0299516 A1
(43) Pub. Date: Oct. 1, 2026

(54) ARBOR FOR A TIMEPIECE BARREL

(71) Applicant: ROLEX SA, Geneva (CH)

(72) Inventor: Jean-Louis Bertrand, Plan-les-Ouates (CH)

(73) Assignee: ROLEX SA, Geneva (CH)

(21) Appl. No.: 19/578,057

(22) Filed: Mar. 25, 2026

(30) Foreign Application Priority Data
Mar. 28, 2025 (EP) 25166996.6

(51) Int. Cl. G04B 1/16

(52) U.S. Cl. CPC G04B 1/16

(57) ABSTRACT

The arbor (10) for a timepiece barrel (100) has a longitudinal axis (A), a first part (1) having a first shoulder (13) to position a drum (4) or a cover (3), and a second part (2) attached or fastened to the first part (1) and having a second shoulder (14) to position a drum (4) or a cover (3), the first part (1) and/or the second part (2) having a first pivoting surface (11) for a drum (4) or a cover (3). The first shoulder (13) and the second shoulder (14) are positioned on either side of the first pivoting surface (11). The first part (1) has a third pivoting surface (21) to cooperate with a first bearing (8) arranged within a blank (81). The second part (2) has a fourth pivoting surface (22) to cooperate with a second bearing (9) arranged within a blank (91). The first part (1) has a second pivoting surface (12) for a cover (3) or a drum (4).

### CROSS-REFERENCE TO RELATED APPLICATION

This application claims priority of European patent application No. EP25166996.6 filed Mar. 28, 2025, the content of which is hereby incorporated by reference herein in its entirety.

### FIELD OF THE INVENTION

The invention relates to an arbor for a timepiece barrel. The invention also relates to a timepiece barrel comprising such a barrel arbor. The invention further relates to a timepiece movement comprising such an arbor or such a barrel. The invention further relates to a timepiece comprising such an arbor or such a barrel or such a timepiece movement. Finally, the invention relates to a method for assembling a timepiece barrel and/or a timepiece movement and/or a timepiece.

### BACKGROUND ART

A barrel generally comprises an arbor cooperating with a spring housed in a drum closed by a cover. It is known that the axial play and runout of the drum relative to the arbor are difficult to control. Indeed, play and runout depend in particular on a long chain of dimensions spread between the arbor, the drum, and the cover, and also depend on the potential deformation of the latter two components, in particular during the mounting of the barrel. For example, the disk shape of the drum and the cover can be warped, which forms a hollow or a concave or convex dome that inevitably influences the play and runout thereof. In order to control play and runout, it is common practice for the barrel to be corrected by a watchmaker.

Document U.S.677689 describes a barrel comprising a two-part arbor, with a first part 12 screwed into a second part 11. The assembly of these two parts makes it possible to trap a barrel cover 1 pivoting, by means of jewels 9, around the second part 11. The axial play of the cover 1 is then defined by a shoulder 14 of the second part 11 of the arbor and a drum 21 secured to the arbor by the first part 12. During operation, the drum 21 and the cover 1 move relative to each other. As a result, the drum 21 cannot be closed by the cover 1 in order to prevent the contamination of the barrel or the migration of lubricant.

### SUMMARY OF THE INVENTION

The aim of the invention is to provide a barrel arbor that overcomes the aforementioned drawbacks and improves the barrel arbors known in the prior art. The invention particularly proposes a barrel arbor that allows improved control of the axial play and runout of the drum by significantly reducing the chain of dimensions.

An arbor according to the invention is defined in point 1 below.
1. An arbor for a timepiece barrel comprising:
   a longitudinal axis,
   a first part comprising a first shoulder intended to position a drum or a cover respectively, and
   a second part attached or fastened to the first part, the second part comprising a second shoulder intended to position a drum or a cover respectively,
   the first part and/or the second part comprising a first pivoting surface for a drum or a cover respectively,
   the first shoulder and the second shoulder being positioned on either side of the first pivoting surface,
the first part comprising a third pivoting surface intended to cooperate with a first bearing arranged within a blank, and
the second part comprising a fourth pivoting surface intended to cooperate with a second bearing arranged within a blank,
the first part comprising a second pivoting surface for a cover or a drum respectively.

Different embodiments of the arbor according to the invention are defined in points 2 to 4 below.
2. The arbor for a timepiece barrel as defined in point 1, wherein:
   the first and second shoulders are opposite each other, or
   the first and second shoulders face each other, or
   the first and second shoulders are arranged facing each other,
so as to axially define, along the longitudinal axis, a drum or a cover respectively, relative to the first part and/or the second part.
3. The arbor for a timepiece barrel as defined in one of the preceding points, wherein the first part comprises a core.
4. The arbor for a timepiece barrel as defined in one of the preceding points, wherein the first part is fastened to the second part by screwing and/or by gluing and/or by driving and/or by welding and/or by riveting.

A barrel according to the invention is defined in point 5 below.
5. A timepiece barrel, comprising:
   a drum,
   a cover,
   a mainspring, and
   an arbor as defined in one of the preceding points.

Different embodiments of the barrel according to the invention are defined in points 6 to 11 below.
6. The timepiece barrel as defined in the preceding point, wherein the cover is assembled on the drum so as to form, with the drum, a closed housing.
7. The timepiece barrel as defined in the preceding point, wherein the cover is assembled on the drum by clipping and/or driving and/or riveting and/or gluing and/or welding.
8. The timepiece barrel as defined in one of points 5 to 7, wherein the timepiece barrel comprises a ratchet and wherein the ratchet is fastened to the first part of the arbor or the second part of the arbor.
9. The timepiece barrel as defined in one of points 5 to 8, wherein the drum comprises a first axial projection cooperating with the first pivoting surface or with the second pivoting surface.
10. The timepiece barrel as defined in one of points 5 to 9, wherein the cover comprises a second axial projection cooperating with the second pivoting surface or with the first pivoting surface.
11. The timepiece barrel as defined in point 9 or 10, wherein:
   the first or the second axial projection, and
   the first shoulder and the second shoulder,
   are arranged so that the first or the second axial projection is axially delimited relative to the longitudinal axis by the first and second shoulders.

A timepiece movement according to the invention is defined in point 12 below.
12. A timepiece movement comprising an arbor as defined in one of points 1 to 4 and/or a timepiece barrel as defined in one of points 5 to 10.

An embodiment of the timepiece movement according to the invention is defined in point 13 below.
13. The timepiece movement as defined in the preceding point, wherein it comprises a first bearing cooperating with the third pivoting surface and comprises a second bearing cooperating with the fourth pivoting surface.

A timepiece according to the invention is defined in point 14 below.
14. A timepiece, in particular a wristwatch, comprising an arbor as defined in one of points 1 to 4 and/or a timepiece barrel as defined in one of points 5 to 11 and or a timepiece movement as defined in point 12 or 13.

An assembly method according to the invention is defined in point 15 below.
15. A method for assembling a timepiece barrel, in particular a timepiece barrel as defined in one of points 5 to 11 and/or a timepiece movement, in particular a timepiece movement as defined in point 12 or 13, and/or a timepiece, in particular a timepiece as defined in point 14, the assembly method comprising at least the following steps:
   supplying a first part of an arbor;
   supplying a drum or a cover respectively;
   placing the drum or the cover respectively on a first pivoting surface or on a portion of a first pivoting surface formed on the first part of the arbor;
   supplying a second part of the arbor;
   fastening or assembling the second part of the arbor on the first part of the arbor;
   or
   at least the following steps:
   supplying a second part of an arbor;
   supplying a drum or a cover respectively;
   placing the drum or the cover respectively on a first pivoting surface or on a portion of a first pivoting surface formed on the second part of the arbor;
   supplying a first part of the arbor;
   fastening or assembling the first part of the arbor on the second part of the arbor.

### BRIEF DESCRIPTION OF THE DRAWINGS

The figures show, by way of example, an embodiment of a timepiece according to the invention.

FIG. 1 is an axial cross-sectional view of the embodiment of a timepiece according to the invention.

FIG. 2 is an exploded perspective view of an embodiment of a barrel arbor.

FIG. 3 is an axial cross-sectional view of the embodiment of the barrel arbor.

### DETAILED DESCRIPTION OF PARTICULAR EMBODIMENTS

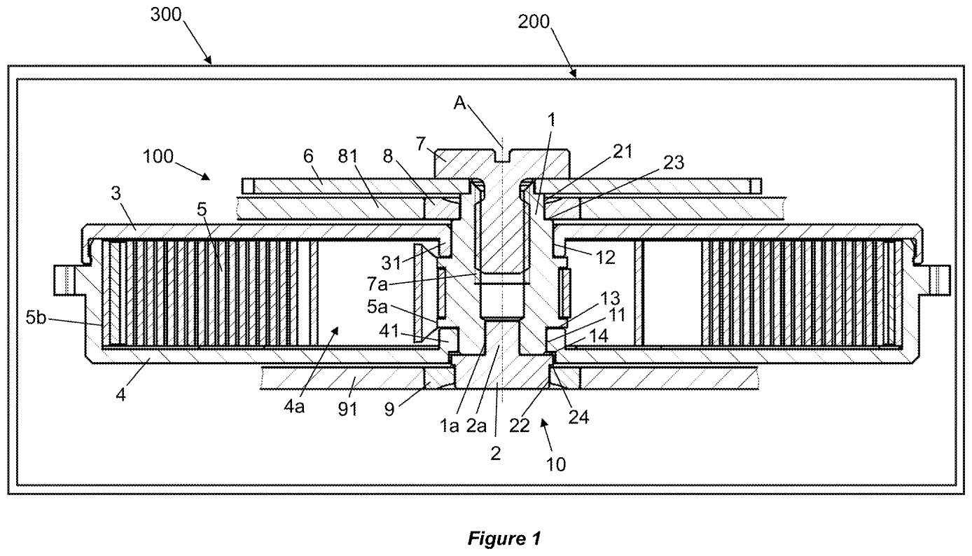

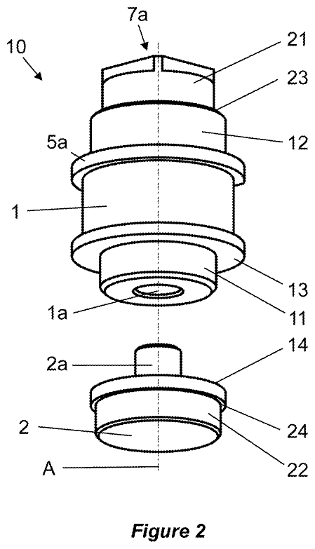

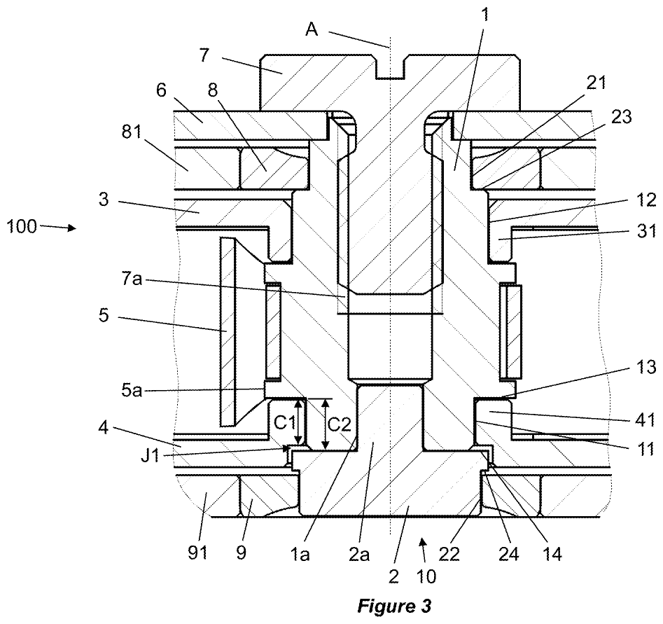

An embodiment of a timepiece 300 according to the invention is described below with reference to FIGS. 1 to 3. The timepiece is for example a watch, in particular a wristwatch. The timepiece comprises a timepiece movement 200. The timepiece movement 200 can be:
a mechanical movement, in particular an automatic movement, or
a hybrid movement.

The timepiece 300 further comprises a case intended to receive the timepiece movement 200 and protect it from the external environment.

The timepiece movement 200 comprises a barrel 100. The barrel 100 comprises:
a drum 4,
a cover 3,
a mainspring 5, and
a barrel arbor 10.

The drum 4 and the cover 3 form an assembly that defines a housing 4a for the mainspring 5. The drum 4 and the cover 3 pivot around the barrel arbor 10.

The barrel makes it possible to store energy, in the form of potential energy due to the elastic deformation of the mainspring, which can be used to maintain the movements of an oscillator via a finishing gear train.

One of the ends of the mainspring 5 (the inner end) cooperates with the arbor 10, and the other end of the mainspring 5 (the outer end) cooperates with the drum 4 so that a rotation of the arbor 10 relative to the drum 4 allows the winding of the mainspring 5 in one direction and in the other direction the unwinding thereof. More particularly, the mainspring 5 extends between a core diameter or a core 5a of the arbor 10 and an inner diameter or an inner wall 5b of the substantially cylindrical drum 4. The core 5a comprises means for hooking one of the ends of the mainspring, and the inner wall 5b can in particular comprise notches for promoting the hooking of the other end of the mainspring 5. The mainspring 5 can optionally be provided with a sliding bridle.

The barrel arbor 10 pivots within blanks 81, 91 of the timepiece movement, such as bridges or plates. This pivoting can take place in particular in bearings, in particular jewels or bushings or ball bearings attached within these blanks. Preferably, the barrel arbor 10 comprises upper and lower pivots intended to cooperate with a first bearing 8 and a second bearing 9 respectively. Preferably, the bearings are first and second jewels 8, 9.

The upper pivot comprises an upper pivoting surface 21 and an upper shoulder 23. Similarly, the lower pivot comprises a lower pivoting surface 22 and a lower shoulder 24. The upper and lower pivoting surfaces 21, 22 ensure that the arbor 10 pivots within the bearings 8 and 9 respectively. The axial play of the barrel 100, or more particularly of the arbor 10, is ensured by the cooperation of the upper and lower shoulders 23, 24 with the bearings 8 and 9 respectively.

The barrel arbor 10 also comprises two other pivots or pivoting portions allowing the relative pivoting of:
the drum 4 around the arbor 10, and
the cover 3 around the arbor 10.

A first pivoting surface 11 allows the drum 4 or the cover 3 respectively to pivot. A second pivoting surface 12 allows the cover 3 or the drum 4 respectively to pivot. Preferably, the first and second pivoting surfaces 11, 12 cooperate respectively with a first projection 41 made on the drum 4 and a second projection 31 made on the cover 3. These projections 31, 41 have a cylindrical portion that extends in a direction substantially parallel to an axis A of rotation of the barrel. The axis A extends in a longitudinal direction relative to the arbor 10 and passes through the center thereof. These projections are made in order to increase the contact areas on the pivoting surfaces 11, 12, which makes it possible to reduce the contact pressure and provide improved guidance, reducing the runout of the drum 4 and the cover 3 in particular.

The drum 4 is intended to receive the mainspring 5 within the housing 4a. As a result, with the arbor 10, the drum 4 receives most of the forces or stresses generated by the winding of the mainspring 5. At least, the drum 4 and the arbor 10 are the components directly loaded by the winding of the mainspring 5.

The drum 4 comprises teeth or any other means making it possible to transmit the energy stored by the mainspring 5 to the gear train of the timepiece movement.

Preferably, the cover 3 is assembled on the drum 4 so that it is fastened thereto and thus produces a secured assembly and forms a closed housing 4a for the mainspring 5. The closed housing 4a thus forms a housing sealed against dust and prevents the potential migration of lubricant inside the barrel. Such a closed housing 4a also makes it possible to prevent the turns of the mainspring 5 from rubbing against a component such as a blank, a bridge, a plate, a mobile, or a mechanism, due to the relative movement of the drum 4.

The cover 3 is preferably assembled on the drum 4 by clipping, in order to make it possible for it to be removed by a watchmaker, for example. More generally, the cover 3 can be assembled on the drum 4 by clipping and/or driving and/or riveting and/or gluing and/or welding.

In order to make it possible to wind the mainspring 5, provision is made so that a wheel, or more particularly a ratchet 6, can be assembled with the arbor 10 or at the very least can be constrained to rotate with the arbor 10. The ratchet 6 is therefore assembled so as to allow the transmission of torque to the arbor 10. As is conventional, torque can be transmitted by cooperation between a square portion formed, in particular machined, in the center of the ratchet 6 and a complementary geometry formed, in particular machined, on the arbor 10 and fitting the square bore.

Alternatively or additionally, the ratchet 6 can be assembled with the arbor 10 in particular by screwing, driving, riveting, gluing, or welding.

The distinctive feature of the solution lies in the fact that the barrel arbor 10 is made in two parts or two separate components 1, 2. The first part 1 is assembled with the second part 2 so that they are completely secured with each other (fixed joint) so as to form the barrel arbor 10. They can be assembled by driving and/or gluing and/or welding and/or screwing and/or riveting or any other means in order to secure the two parts 1, 2.

The first part 1 of the arbor 10 can comprise:
the core 5a,
the upper pivoting surface 21 and the upper shoulder 23 intended to cooperate with the first bearing 8,
the first pivoting surface 11 and/or the second pivoting surface 12 allowing the drum 4 and/or the cover 3 to pivot.

Preferably, the ratchet 6 is assembled on the first part 1 of the arbor 10, so as to ensure optimum and/or reliable torque transmission between the ratchet 6 and the hook of the mainspring 5 during the winding thereof.

In order to prevent any assembly or torque resistance problems, the core 5a is advantageously is made in one piece with the first part 1 of the arbor 10.

The second part 2 can comprise:
the lower pivoting surface 22, and
the lower shoulder 24 intended to cooperate with the second bearing 9.

The second part 2 can comprise the first pivoting surface 11. In other words, if it is not already included in the first part 1, the second part 2 can comprise the first pivoting surface 11.

Thus, the first part 1 advantageously comprises a third pivoting surface 21 intended to cooperate with the first bearing 8, which is arranged within a blank 81, and the second part 2 advantageously comprises a fourth pivoting surface 22 intended to cooperate with the second bearing 9, which is arranged within a blank 91.

The fact that the barrel arbor 10 is in two parts 1, 2 advantageously makes it possible to delimit the cover 3 or the drum 4 between:
a first shoulder 13 included in the first part 1 or formed on the first part 1, and
a second shoulder 14 included in the second part 2 or formed on the second part 2.

The cover 3 or the drum 4 can thus be delimited axially, along the longitudinal axis A, relative to the first part 1 and/or the second part 2 or, more generally, relative to the arbor 10.

The arbor 10 thus comprises:
the first part 1 comprising the first shoulder 13 intended to position the drum 4 or the cover 3 respectively, and
the second part 2 attached or fastened to the first part 1, the second part comprising the second shoulder 14 intended to position the drum 4 or the cover 3 respectively.

The first part 1 and/or the second part 2 comprise(s) a first pivoting surface 11 for the drum 4 or the cover 3 respectively. In addition, the first shoulder 13 and the second shoulder 14 are arranged on either side of the first pivoting surface 11.

The first and second shoulders 13, 14 are opposite each other or face each other or are arranged facing each other in order to form an upper axial stop and a lower axial stop respectively, limiting the axial movement of the cover 3 or the drum 4 in both directions of translation along the axis A. Preferably, the first and second shoulders 13, 14 are adjacent to the first pivoting surface 11, and are positioned on either side of the first pivoting surface 11.
The first or the second axial projection 41, 31 and
the first shoulder 13 and the second shoulder 14,
are advantageously arranged so that the first or the second axial projection 41, 31 is axially delimited relative to the longitudinal axis A by the first and second shoulders 13, 14.

As a result, the axial play J1 of the drum 4 or the cover 3 is advantageously provided by the arbor 10, and depends on a minimum of just two dimensions. The axial play J1 can therefore be the result of:
a first dimension C1 defining the length of the cylindrical portion of the first projection 41 or of the second projection 31 of the pivoting surface for the drum 4 or the cover 3, and
a second dimension C2 defining the length of the first pivoting surface 11. The dimensions C1 and C2 are preferably turned with great precision. Consequently, unlike the barrels known in the prior art, the proposed solution allows improved control of the axial play J1, as this play results from a very short chain of dimensions and is advantageously not dependent on the axial position of the bearings 8, 9 or the axial deformation of the drum 4 or the cover 3. Advantageously, with such a solution, it is not necessary, or it is even no longer possible, for a watchmaker to correct the axial play J1 of the barrel 100.

On a conventional barrel, from each of its ends, the barrel arbor comprises a series of increasingly large diameters and shoulders until it reaches a central portion with the largest diameter, which generally corresponds to the core diameter. Using a barrel arbor 10 in two parts 1, 2 also provides the advantage of allowing more freedom of design, in particular by making it possible to reduce the diameter of the core 5a. Indeed at the interface of the two parts 1, 2, it is advantageously possible to obtain the first pivoting surface 11 with a diameter less than or equal to the diameter of the adjacent fourth pivoting surface 22.

Consequently, the core 5a, which is generally adjacent to the first pivoting surface 11, can have a reduced diameter compared to a conventional barrel. This results in an increased volume of the mainspring housing and consequently an increased power reserve.

In the embodiment specifically shown in FIGS. 1 to 3, the cover 3 is fastened to the barrel drum 4 by peripheral clipping so as to form a secured assembly having a closed housing 4a for the mainspring 5.

In the embodiment specifically shown in FIGS. 1 to 3, the drum 4 and the cover 3 pivot respectively on the first and second pivoting surfaces 11, 12, which are made on the first part 1 of the arbor 10. The first pivoting surface 11 is located between:
the core 5a, and
the lower end of the first part 1.

The second pivoting surface 12 is located between:
the core 5a, and
the third pivoting surface 21.

The upper shoulder 23 is adjacent to the third pivoting surface 21 and to the second pivoting surface 12.

A square is machined on the upper end of the first part 1 of the barrel arbor 10 in order to receive the ratchet 6. The upper end of the first part 1 also comprises an internal thread 7a intended to receive a screw 7 that makes it possible to fasten the ratchet 6 to the barrel arbor 10. The square, the internal thread 7a and the screw 7 are advantageously arranged concentrically with the axis A of rotation of the barrel. Preferably, the ratchet 6 is therefore fastened to the first part 1 of the arbor 10.

The second part 2 is assembled on the first part 1 at the lower end of the first part 1. The second part 2 preferably comprises a portion 2a, in particular a stud or a post 2a, intended to be driven into a hole 1a made in the first part 1 of the arbor 10. The hole 1a and the stud 2a can be concentric with the axis A of the arbor 10, and more generally with the axis A of rotation of the barrel. However, it is also possible to carry out the reverse, with a stud made on the first part and a hole made in the second part. As another alternative, with a fastening system allowing precise alignment, it is also possible to assemble the first and second parts 1, 2 without producing a hole 1a or a stud 2a.

The second part 2 further comprises the fourth pivoting surface 22 with the adjacent lower shoulder 24.

Advantageously, the first and second shoulders 13, 14 are adjacent to the first pivoting surface 11, and are positioned on either side thereof, so as to provide optimum control of the axial play J1 of the drum 4 within the arbor 10. In the embodiment specifically shown in FIGS. 1 to 3, the first shoulder 13 is located on the first part 1 and the second shoulder 14 is located on the second part 2.

As a result, the axial play J1 depends on just two dimensions C1 and C2. In addition, although the drum 4 undergoes most of the forces and stresses generated by the mainspring 5, any deformation thereof does not thus influence the axial play J1. However, relative to the arbor 10, the axial position of the cover 3 depends on the axial position of the drum 4 and any deformation thereof. Consequently, sufficient axial play must be provided between the cover 3 and the arbor 10 in order to prevent any jamming or excessive friction of the pivoting action. Such a structure also makes it possible to provide improved holding of the cover 3 on the drum 4 by preventing it from undergoing axial stresses caused by the pivoting thereof around the arbor 10. In other words, with such a solution, the arbor 10 can advantageously no longer exert a contact force on the cover 3 that is capable of removing it.

The first dimension C1 defines the length of the pivoting surface for the drum 4 and the second dimension C2 defines the length of the first pivoting surface 11 on the first part 1 of the arbor. The play J1 is therefore the result of the dimensions C1, C2.

The invention also relates to a method for assembling a barrel or a timepiece movement or a timepiece. One implementation of an embodiment of the aforementioned barrel is particularly described below. The assembly method comprises at least the following steps:
a. Supplying the first part 1 of the arbor 10;
b. Supplying the drum 4 or the cover 3 respectively;
c. Placing the drum 4 or the cover 3 respectively on the first pivoting surface 11 or on a portion of the first pivoting surface 11 formed on the first part 1 of the arbor 10;
d. Supplying the second part 2 of the arbor 10;
e. Fastening or assembling the second part 2 of the arbor 10 on the first part 1 of the arbor 10.

As an alternative, the assembly method comprises at least the following steps:
a. Supplying the second part 2 of the arbor 10;
b. Supplying the drum 4 or the cover 3 respectively;
c. Placing the drum 4 or the cover 3 respectively on the first pivoting surface 11 or on a portion of the first pivoting surface 11 formed on the second part 1 of the arbor 10;
d. Supplying the first part 1 of the arbor 10;
e. Fastening or assembling the first part 1 of the arbor 10 on the second part 1 of the arbor 10.

The fastening or assembly makes it possible to axially define (relative to the axis A) the drum 4 or the cover 3 respectively between the two parts 1 and 2.

The assembly method can further comprise the following steps:
f. Supplying the cover 3 or the drum 4 respectively;
g. Placing the mainspring 5;
h. Placing the cover 3, or the drum 4 respectively, on the second pivoting surface 12;
i. Assembling the cover (3) and the drum (4), in particular by clipping and/or driving and/or riveting and/or gluing and/or welding.

The timepiece barrel 10 thus assembled is then mounted on the blanks to form the timepiece movement 200.

In the assembly method, step e. is performed after step c.

In the embodiment described, the ratchet 6 is assembled on the first part 1 of the arbor. However, whatever the embodiment and variant, it is also possible for the ratchet 6 to be assembled on the second part 2. Consequently, the square would be made on said second part. The internal thread 7a could then be made on the second part 2, or on the lower end of the first part 1. With the last variant, the second part 2 could then be fastened to the first part 1 by the screw 7 also fastening the ratchet 6. The second part 2 and the ratchet 6 would then be sandwiched between the screw 7 and the first part 1.

As a further alternative, whatever the embodiment and variant, the barrel can also be constructed with the ratchet 6 assembled between the first and second parts 1, 2. The ratchet 6 could thus make it possible to limit the axial play of the drum 4 or of the cover 3 by comprising the first shoulder 13 or the second shoulder 14.

As a further alternative, whatever the embodiment and variant, the ratchet 6 can be included in the first part 1 or the second part 2, or be formed on the first part 1 or the second part 2.

With respect to the embodiment shown, it is also possible to invert the positions of the drum 4 and the cover 3. The cover 3 would then pivot on the lower side and the drum 4 on the upper side.

In the embodiment shown in FIGS. 1 to 3, the first part 1 comprises the first pivoting surface 11 for the drum 4. As an alternative, whatever the embodiment and variant, the second part 2 can comprise the first pivoting surface for the drum or the cover. As a further alternative, whatever the embodiment and variant, the first part and the second part can together comprise the first pivoting surface for the drum or the cover. In this last case, the first pivoting surface for the drum or the cover is made:
partially on the first part, and
partially on the second part.

Whatever the embodiment and variant, the maximum diameter of the arbor 1 can be less than 3.5 mm, or less than 2.5 mm, or of the order of 1.8 or 1.4 mm.

Whatever the embodiment and variant, the diameter of the first pivoting surface 11 can be at least substantially equal to, or less than, the diameter of the fourth pivoting surface 22.

Thanks to the solutions described above, the two-part barrel arbor makes it possible to reduce the space occupied by the barrel or the safety spaces, the clearances, around the barrel within a movement, in particular by virtue of improved control of the axial play of the drum, while increasing the internal volume available for the mainspring. The solutions described above further make it possible to minimize runout and thus prevent undue contact between the cover or the drum and the blanks.

More specifically, such a structure advantageously allows:
improved control of the axial play and runout of the drum by significantly reducing the chain of dimensions and therefore the tolerance of the resulting axial play,
axial play that is not influenced by the potential deformation of the barrel drum or cover,
improved holding of the cover by preventing it from undergoing axial stresses caused by the pivoting thereof around the arbor.

Finally, this structure also provides greater freedom with respect to the definition of the barrel, in particular by making it possible to reduce the core diameter of the arbor.

1. An arbor for a timepiece barrel, the arbor comprising:
a longitudinal axis,
a first part comprising a first shoulder intended to position a drum or a cover respectively, and
a second part attached or fastened to the first part, the second part comprising a second shoulder intended to position a drum or a cover respectively,
the first part and/or the second part comprising a first pivoting surface for a drum or a cover respectively,
the first shoulder and the second shoulder being positioned on either side of the first pivoting surface,
the first part comprising a third pivoting surface intended to cooperate with a first bearing arranged within a blank, and
the second part comprising a fourth pivoting surface intended to cooperate with a second bearing arranged within a blank,
the first part comprising a second pivoting surface for a cover or a drum respectively.

2. The arbor for a timepiece barrel as claimed in claim 1, wherein:
the first and second shoulders are opposite each other, or
the first and second shoulders face each other, or
the first and second shoulders are arranged facing each other,
so as to axially define, along the longitudinal axis, a drum or a cover respectively, relative to the first part and/or the second part.

3. The arbor for a timepiece barrel as claimed in claim 1, wherein the first part comprises a core.

4. The arbor for a timepiece barrel as claimed in claim 1, wherein the first part is fastened to the second part by screwing and/or by gluing and/or by driving and/or by welding and/or by riveting.

5. A timepiece barrel, comprising:
a drum,
a cover,
a mainspring, and
an arbor as claimed in claim 1.

6. The timepiece barrel as claimed in claim 5, wherein the cover is assembled on the drum so as to form, with the drum, a closed housing.

7. The timepiece barrel as claimed in claim 6, wherein the cover is assembled on the drum by clipping and/or driving and/or riveting and/or gluing and/or welding.

8. The timepiece barrel as claimed in claim 5, wherein the timepiece barrel comprises a ratchet fastened to the first part of the arbor or the second part of the arbor.

9. The timepiece barrel as claimed in claim 5, wherein the drum comprises a first axial projection cooperating with the first pivoting surface or with the second pivoting surface.

10. The timepiece barrel as claimed in claim 5, wherein the cover comprises a second axial projection cooperating with the second pivoting surface or with the first pivoting surface.

11. The timepiece barrel as claimed in claim 9. wherein:
the first or the second axial projection, and
the first shoulder and the second shoulder,
are arranged so that the first or the second axial projection is axially delimited relative to the longitudinal axis by the first and second shoulders.

12. A timepiece movement comprising an arbor as claimed in claim 1.

13. The timepiece movement as claimed in claim 12, wherein the timepiece movement comprises a first bearing cooperating with the third pivoting surface and a second bearing cooperating with the fourth pivoting surface.

14. A timepiece comprising an arbor as claimed in claim 1.

15. A method for assembling a timepiece barrel, the method comprising:
providing a first part of an arbor;
providing a drum or a cover respectively;
placing the drum or the cover respectively on a first pivoting surface or on a portion of a first pivoting surface formed on the first part of the arbor;
providing a second part of the arbor;
fastening or assembling the second part of the arbor on the first part of the arbor.

16. The arbor for a timepiece barrel as claimed in claim 2, wherein the first part comprises a core.

17. The arbor for a timepiece barrel as claimed in claim 2, wherein the first part is fastened to the second part by screwing and/or by gluing and/or by driving and/or by welding and/or by riveting.

18. The arbor for a timepiece barrel as claimed in claim 3, wherein the first part is fastened to the second part by screwing and/or by gluing and/or by driving and/or by welding and/or by riveting.

19. A timepiece barrel, comprising:
a drum,
a cover,
a mainspring, and
an arbor as claimed in claim 2.

20. The timepiece barrel as claimed in claim 19, wherein the cover is assembled on the drum so as to form, with the drum, a closed housing.
